(19) United States
(12) Patent Application Publication
(10) Pub. No.: US 2003/0110672 A1
(43) Pub. Date: Jun. 19, 2003

(54) Photo album page systems

(76) Inventor: Whang Kwee Tan, Singapore (SG)

Correspondence Address: Whang Kwee Tan, 30 Mandai Estate, # 06-01 Mandai Industrial Building, Singapore, 729918, SG

(21) Appl. No.: 10/020,028

(22) Filed: Dec. 14, 2001

(51) Int. Cl. G09F 19/00

(52) U.S. Cl. 40/530

(57) ABSTRACT

A photo album page system comprises a rectangular piece. The piece has an upper edge, a lower edge and side edges. The piece has an extent. The extent is a mounting region for positioning pages within a photo album. The mounting region has a central vertical fold line and spaced circular apertures on opposite sides of the fold line at the center. Also provided is a piece of cardboard adjacent to the fold line. Glue couples the cardboard to the mounting region over the apertures. Short projections are provided above and below the mounting region to aid in the mounting of the pages into a photo album. Provide last are at least two pages. One rectangular mounting zone is provided per page. Each mounting zone includes mounting components adjacent to each mounting zone. Each mounting zone is adapted to removably receive and support a photo.

### BACKGROUND OF THE INVENTION

1. Field of the Invention

The present invention relates to photo album page systems and more particularly pertains to removably coupling photos to pages of simplified sheet constructions and for positioning the pages into a photo album.

2. Description of the Prior Art

Photo album pages play a very important role in the success of any photo album. As the appearance of the pages in the market now offers a very little choice to consumers, there is a very high potential opportunity to improve the attractiveness of the pages that could lead to better consumer satisfaction. Meanwhile, there are only three major categories of photo album pages in the market. The first type is the self-adhesive page. The second type is the plastic pocket. The third type is just plain paperboard.

The disadvantage of the self-adhesive page are that many consumers complain that the chemical within the adhesive will cause the photographs to turn yellowish and photographs are hard to remove over time.

The disadvantage of the plastic pocket type is that it looks very low end. As most people regard their memories to be one of their most important things in life, therefore, they tend to hope their memories to be kept in a very nice album with nice pages. But there is also advantage to this type of page, which is indeed very convenient for consumers to store photographs.

The disadvantage of the plain paperboard is that consumers need to purchase additional photo corners separately to hold their photographs, which is a very big draw back of this type of pages. The advantage is that it has a high end look which gives it a high perceived value.

And so far there is no one photograph album that has more than one look within itself. For example, the plastic pocket page only has plastic pockets and the self-adhesive page only has adhesive and the paperboard is only having paperboard. It will be more interesting if a photograph album that could be more decorative and artistic.

The use of photo album pages of known designs and configurations is known in the prior art. More specifically, photo album pages of known designs and configurations previously devised and utilized for the purpose of coupling photos to photo album pages through known methods and apparatuses are known to consist basically of familiar, expected, and obvious structural configurations, notwithstanding the myriad of designs encompassed by the crowded prior art which has been developed for the fulfillment of countless objectives and requirements.

In this respect, the photo album page systems according to the present invention substantially departs from the conventional concepts and designs of the prior art, and in doing so provides an apparatus primarily developed for the purpose of removably coupling photos to pages of simplified sheet constructions and for positioning the pages into a photo album.

Therefore, it can be appreciated that there exists a continuing need for a new and improved photo album page systems which can be used for removably coupling photos to pages of simplified sheet constructions and for positioning the pages into a photo album. In this regard, the present invention substantially fulfills this need.

### SUMMARY OF THE INVENTION

In view of the foregoing disadvantages inherent in the known types of photo album pages of known designs and configurations now present in the prior art, the present invention provides an improved photo album page systems. As such, the general purpose of the present invention, which will be described subsequently in greater detail, is to provide a new and improved photo album page systems and method which has all the advantages of the prior art and none of the disadvantages.

To attain this, the present invention essentially comprises a rectangular piece of fine grade paper. The piece is of substantial rigidity and limited flexibility. The piece is to be used as pages in a photo album. The piece has an upper edge and a substantially parallel lower edge and with parallel side edges. Next provided is a central vertical extent of the piece. The extent constitutes a mounting region for positioning pages within a photo album. The mounting region has a central vertical fold line. The mounting region also has spaced vertical central slots. The mounting region further has spaced circular apertures on opposite sides of the fold line at the center. A long narrow piece of thick cardboard is provided adjacent to the fold line. Lines of glue couple the cardboard to the mounting region over the apertures. The height of the thick cardboard is greater than the length of the side edges. In this manner short projections are provided above and below the mounting region to aid in the mounting of the pages into a photo album. Also provided are secondary fold lines. The secondary fold lines extend vertically through the piece midway between each side edge and the mounting region. The fold lines are adapted to allow each lateral side of the piece opposite from the fold line to be overlaid one with respect to the other. Horizontal lines of glue are provided. The lines of glue extend at spaced locations across the piece. These four pages are the front and back faces of the two sheets. Each of the two sheets are formed with two rectangular mounting zones. Each mounting zone includes four corner slits, preferably L-shaped, with outwardly extending extensions adjacent to each corner of each mounting zone. The extensions are adapted to removably receive and support the corners of a photograph. Finally, raised embossing is provided. The embossing is provided circumferentially around each of the mounting zones on each of the pages.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved photo album page systems which has all of the advantages of the prior art photo album pages of known designs and configurations and none of the disadvantages.

It is another object of the present invention to provide a new and improved photo album page systems which may be easily and efficiently manufactured and marketed.

It is further an object of the present invention to provide a new and improved photo album page systems which is of durable and reliable constructions.

An even further object of the present invention is to provide a new and improved photo album page systems which is susceptible of a low cost of manufacture with regard to both materials and labor, and which accordingly is then susceptible of low prices of sale to the consuming public, thereby making such photo album page systems economically available to the buying public.

Even still another object of the present invention is to provide a photo album page systems for removably coupling photos to pages of simplified sheet constructions and for positioning the pages into a photo album.

Lastly, it is an object of the present invention to provide a new and improved photo album page system comprising a rectangular piece. The piece has an upper edge, a lower edge and side edges. The piece has an extent. The extent is a mounting region for positioning pages within a photo album. The mounting region has a central vertical fold line and spaced circular apertures on opposite sides of the fold line at the center. Also provided is a piece of cardboard adjacent to the fold line. Glue couples the cardboard to the mounting region over the apertures. Short projections are provided above and below the mounting region to aid in the mounting of the pages into a photo album. Provide last are at least two pages. One rectangular mounting zone is provided per page. Each mounting zone includes mounting components adjacent to each mounting zone. Each mounting zone is adapted to removably receive and support a photo.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of a photo album page system constructed in accordance with the principles of the present invention.

FIG. 2 is a plan view of the photo album page system shown in FIG. 1.

FIGS. 3 and 3A are a photo album page systems as shown in FIGS. 1 and 2 but illustrating the constructions for 8 photos and for 4 photos prior to folding.

FIG. 4 is a front elevational view of a photo album page system constructed in accordance with an alternate embodiment of the invention.

FIG. 5 is a plan view of the photo album page system shown in FIG. 4.

FIG. 6 is a perspective illustration of a photo album page system constructed in accordance with another alternate embodiment of the invention.

FIG. 7 is a plan view of the photo album page system shown in FIG. 6.

FIG. 8 is an exploded perspective view taken at Circle 8 of FIG. 6.

FIG. 9 is a perspective illustration of one of the corner tabs shown in FIG. 6, 7 and 8.

FIG. 10 is a perspective illustration of an alternate design of a corner tab similar to that shown in FIG. 9.

FIG. 11 is a perspective view similar to FIG. 8 but showing an alternate slot and insert construction.

FIG. 12 is a perspective illustration of the tab shown in FIG. 11.

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved photo album page systems embodying the principles and concepts of the present invention and generally designated by the reference numeral 10 will be described.

The present invention, the photo album page systems 10 is comprised of a plurality of components. Such components in their broadest context include a rectangular piece, a vertical extent, a long narrow piece of thick cardboard and at least two pages. Such components are individually configured and correlated with respect to each other so as to attain the desired objective.

First provided is a rectangular piece 12 of fine grade paper. The piece is of substantial rigidity and limited flexibility. The piece is to be used as pages in a photo album. The piece has an upper edge 14 and a substantially parallel lower edge 16 and with parallel side edges 18.

Next provided is a central vertical extent of the piece. The extent constitutes a mounting region 20 for positioning pages within a photo album. The mounting region has a central vertical fold line 22. The mounting region also has spaced vertical central slots 24. The mounting region further has spaced circular apertures 26 on opposite sides of the fold line at the center.

A long narrow piece of thick cardboard 28 is provided adjacent to the fold line. Lines of glue 30 couple the cardboard to the mounting region over the apertures. The height of the thick cardboard is greater than the length of the side edges. In this manner short projections 32 are provided above and below the mounting region to aid in the mounting of the pages into a photo album.

Also provided are secondary fold lines 34. The secondary fold lines extend vertically through the piece midway between each side edge and the mounting region. The fold lines are adapted to allow each lateral side of the piece opposite from the fold line to be overlaid one with respect to the other. Horizontal lines of glue 36 are provided. The lines of glue extend to form four pages. Note the dotted lines of FIG. 1. These four pages are the front and back faces 38, 39 of the two sheets. Each of the two sheets are formed with two rectangular mounting zones 40. Each mounting zone includes four corner slits 42, preferably L-shaped, with outwardly extending extensions 44 adjacent to each corner of each mounting zone. The extensions are adapted to removably receive and support the corners of a photograph. Slits of other shapes could readily be utilized in order to enhance the appearance of a page.

Finally, raised embossing 52 is provided. The embossing is provided circumferentially around each of the mounting zones on each of the pages. The raised embossing precludes facing photos from contacting each other which might cause sticking and/or degradation of the photos.

Each mounting zone is also preferably provided with smaller interior concentric embossing 52 with interior corner slits 42A with extensions 44A. In this manner, each mounting zone is capable of supporting either a larger photo or a smaller photo.

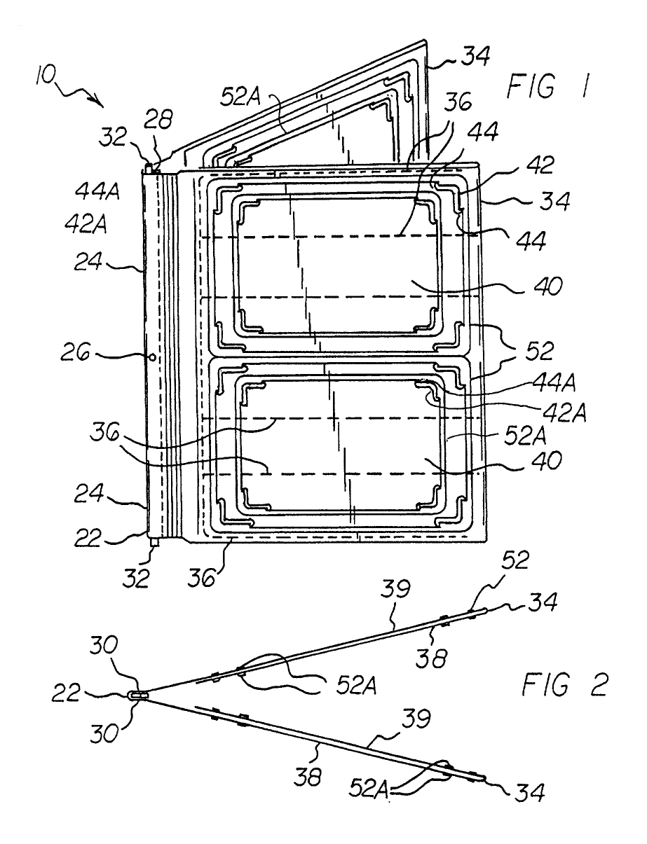

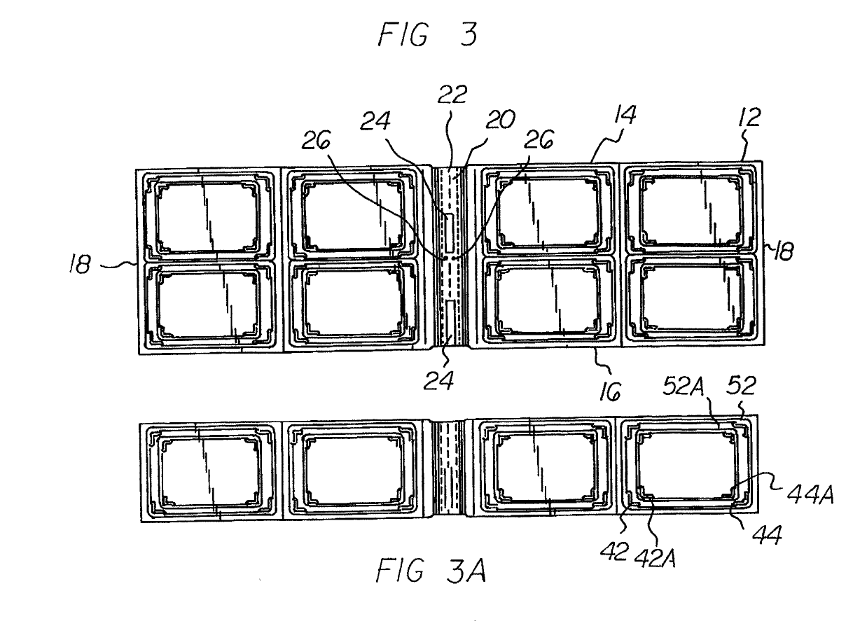

In the embodiment shown in FIGS. 1-3 each sheet is formed of two layers with slits in the corners of the mounting zones so that separate photos may be removably received within the slits of each page.

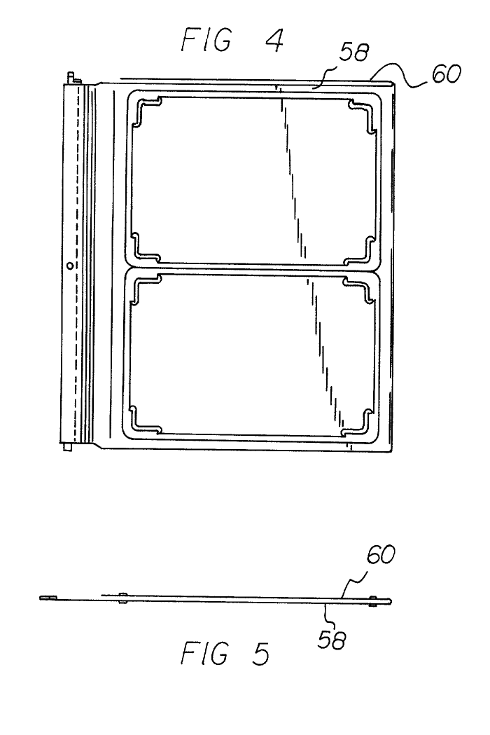

In the embodiment shown in FIGS. 4 and 5, each sheet includes but two pages 58, 60 with the pages being of double thickness with corner slits for each page for the removably receipt of photos. More specifically, the system includes two pages with two mounting zones on each page and four corner slits per mounting zone.

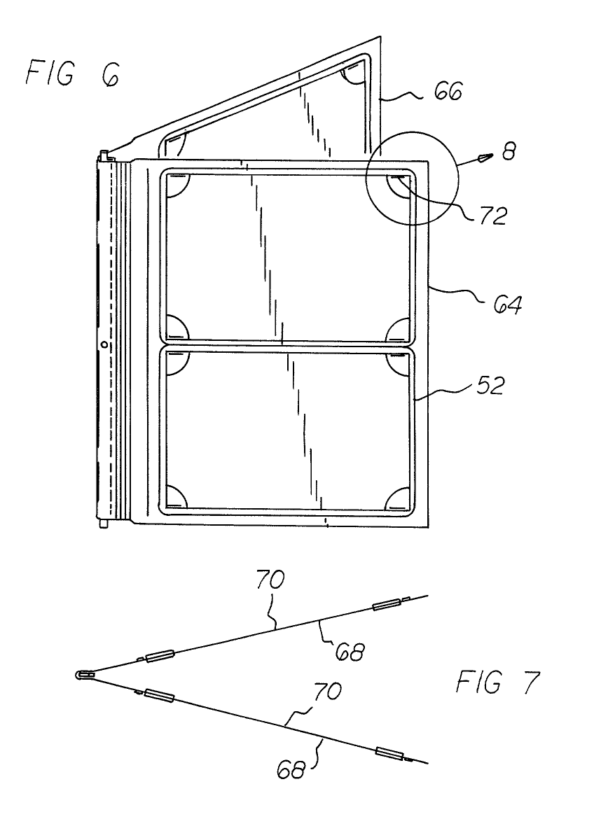

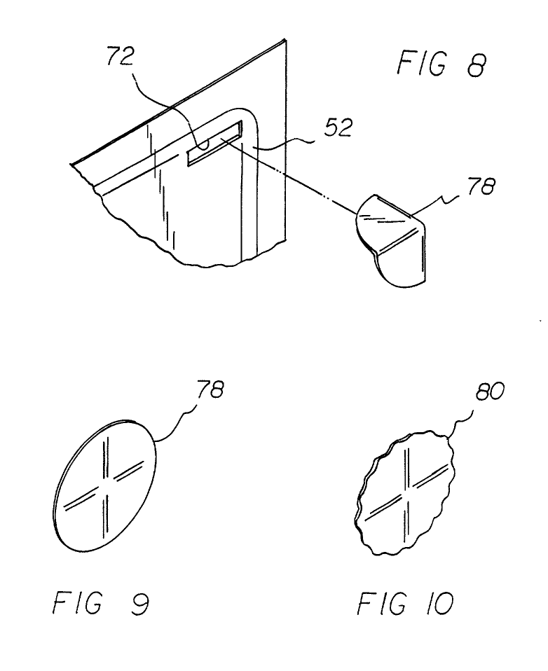

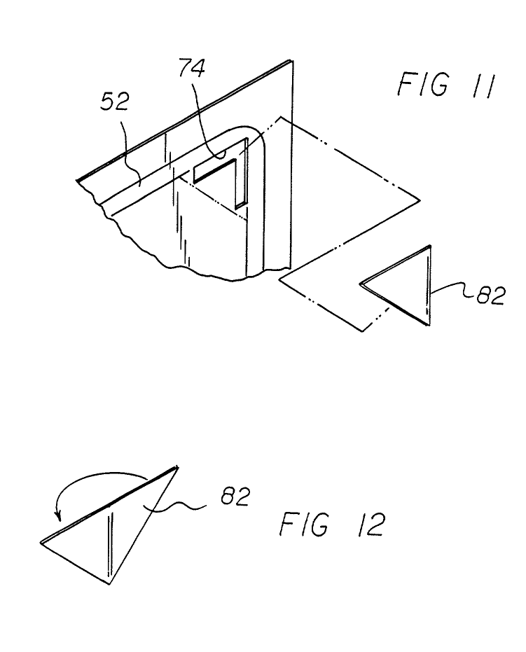

The embodiments as shown in FIGS. 6 through 12 includes two sheets 64, 66 and four pages 68, 70 wherein each sheet is of a single thickness. L-shaped, or in the alternative horizontal, slots 72, 74 adjacent the four mounting zones permit removable coupling of a photo to each mounting zone including on the opposite sides of a sheet of a single thickness. Two pages are coupled through a common mounting zone. Each page is of a single thickness. Each sheet has horizontal slots 72 in FIGS. 6 through 10. The horizontal slots are adjacent the corners of each mounting zone. A generally circular tab 78 is provided. The tab is folded diametrically then folded in half again and positioned halfway through the slot. The edges of the tabs may have scalloped edges 80. In this manner a photo receiving corner is provided for the four corners of each photo. The slots 74 may alternatively be of an L-shaped configuration as shown in FIGS. 11 and 12 and the tabs 82 of a square configuration.

From the foregoing, it can be understood that the present invention is a photograph album that has different formats of pages, and each type of the pages is unique by itself, very decorative and artistic.

To make the first type of album pages, FIGS. 1-3, the following are needed: 1) a piece of fine grade paper with perforations and raised borders; 2) special patterns are die-cut in the paper; 3) a long narrow piece of thick cardboard. Making this page is very simple. First, apply adhesive to the three open sides of the paper. Then, fold the two portions together along the guide line and making a two layer page. Then, adhere the long specially designed cardboard to the left-most side of the page where the perforation is. The thick long narrow cardboard is used to holding pages to the spine holder. The die-cut patterns on the page are designed toa llow the insert of the corners of the photographs. The distance between each of the die-cut patterns should be according to the size of the photographs intended to hold. Another feature in this type of page is that there are raised borders on the paper for each of the space for the photographs. The purposes of the raised borders are to prevent the photographs from sticking together when face to face, and the other purpose is for decoration.

To make the second type of photo album page, FIGS. 6-12, the following are needed: 1) a piece of fine grade paper with die-cut patterns; 2) a long narrow thick piece of cardboard; 3) a number of corners made of paper or other material. Unlike the first type of page mentioned above. The second type of album page only has one layer. But similarly, a long narrow thick piece of cardboard is also used. The paper first must have pre-designed die-cut patterns used to receive corners. There are basically two types of corners. The first is designed to have three layers and the second is with four layers. The corners are the key component of this page. The corners are designed to position firmly in the die-cut patterns. They are positioned firmly to the die-cut patterns by applying a minimum of adhesive in the middle layer of the corners. Because the die-cut patterns on the paper are cut-through patterns. Therefore, each side of the paper will have a corner created. The distance between die-cut patterns on the paper will determine the size of the photographs that it will hold.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by letters patent of the united states is as follows:

1. A photo album page system for the removable coupling of photos to pages of a simplified sheet constructions and for positioning the pages into a photo album comprising, in combination:
a rectangular piece of fine grade paper of substantial rigidity and limited flexibility for use as pages in a photo album, the piece having an upper edge and a substantially parallel lower edge and with parallel side edges there between;
a central vertical extent of the piece constituting a mounting region for removable positioning pages within a photo album, the mounting region having a central vertical fold line with spaced vertical central slots and spaced circular apertures on opposite sides of the fold line at the center thereof;
a long narrow piece of thick cardboard adjacent to the fold line with lines of glue coupling the cardboard to the mounting region over the apertures, the height of the thick cardboard being greater than the length of the side edges to provide short projections above and below the mounting region to aid in the mounting of the pages into a photo album;
secondary fold lines extending vertically through the piece midway between each side edge and the mounting region, the fold lines adapted to allow each lateral side of the piece opposite from the fold line to be overlaid one with respect to the other, with horizontal lines of glue extending at spaced locations across the piece, to thereby form four pages, the front and back faces of two sheets, for a photo album, each of the two sheets being formed with two rectangular mounting zones, each mounting zone including four L-shaped corner slits with outwardly extending extensions adjacent to each corner of each mounting zone adapted to removably receive and support the corners of a photograph; and
raised embossing circumferentially around each of the mounting zones on each of the pages.

2. A photo album page system comprising:
a rectangular piece having an upper edge and a substantially parallel lower edge and with parallel side edges there between;
a vertical extent of the piece constituting a mounting region for removable positioning pages within a photo album, the mounting region having a central vertical fold line and spaced circular apertures on opposite sides of the fold line at the center thereof;
a long narrow piece of thick cardboard adjacent to the fold line with lines of glue coupling the cardboard to the mounting region over the apertures, the height of the cardboard being greater than the length of the side edges to provide short projections above and below the mounting region to aid in the mounting of the pages into a photo album; and
at least two pages with at least one rectangular mounting zone per page, each mounting zone including mounting components adjacent to each mounting zone, each mounting zone adapted to removably receive and support a photo.

3. The system as set forth in claim 2 wherein each sheet includes two pages with two mounting zones on each page and four corner slits per mounting zone.

4. The system as set forth in claim 2 wherein two pages are coupled through a common mounting zone and each page is of a single thickness, each sheet having horizontal slots adjacent the corners of each mounting zone and further including a generally circular tab folded diametrically then folded in half again and positioned halfway through the slot whereby a photo receiving corner is provided for the four corners of each photo.

5. The system as set forth in claim 2 wherein two pages are coupled through a common mounting zone and each page is of a single thickness, each sheet having L-shaped slots adjacent the corners of each mounting zone and further including a generally circular tab folded diametrically then folded in half again and positioned halfway through the slot whereby a photo receiving corner is provided for the four corners of each photo.

6. The system as set forth in claim 2 wherein the mounting zones have embossing in a rectangular configuration with corner slits and smaller interior concentric embossing with interior corner slits to the mounting zones capable of supporting either a larger photo or a smaller photo.
